(19) United States
(12) Patent Application Publication
(10) Pub. No.: US 2017/0245667 A1
(43) Pub. Date: Aug. 31, 2017

(54) Clean Up Germs Before and After - a Food-Industry-Technology Helper System

(71) Applicant: William S. Gaines, Philadelphia, PA (US)

(72) Inventor: William S. Gaines, Philadelphia, PA (US)

(21) Appl. No.: 15/404,073

(22) Filed: Jan. 11, 2017

Related U.S. Application Data
(60) Provisional application No. 62/277,332, filed on Jan. 11, 2016.

(51) Int. Cl. A47G 23/02; B65D 25/20; A01K 13/00; A47K 7/03; B60S 3/00; A47L 25/08; B65D 81/38; B65D 75/58

(52) U.S. Cl. CPC A47G 23/0216; B65D 81/3876; B65D 25/205; B65D 75/58; A47K 7/03; B60S 3/008; A47L 25/08; A01K 13/001

(57) ABSTRACT

The present disclosed subject matter relates to an apparatus and system for maintaining cleanliness when using commercial beverage containers. The system comprises a cup sleeve for a food or beverage cup comprising one or more generally rectangular packets comprising one or more multi-purpose wipes which form the cup sleeve and additionally provide an insulation for the user.

### CROSS-REFERENCE TO RELATED APPLICATIONS

This non-provisional application claims benefit of priority to U.S. Provisional Patent Application 62/277,332, filed Jan. 11, 2016. The entire disclosure of the aforementioned application is incorporated herein by reference.

### TECHNICAL FIELD

The present invention relates to an apparatus and method for maintaining cleanliness when eating or drinking contents from cup-like containers. More particularly, the present subject matter relates to a cup sleeve made of one or more multi-purpose wipe packets. The present invention also relates to a telescopic cup sleeve made of at least two multi-purpose wipe packets.

### BACKGROUND

Man has always sought to develop methods to clean himself before and after consuming a meal. Chad Upton provides the following brief historical narrative regarding the use of wet towels before consuming a meal.

“If you've ever flown first class or eaten at a first class restaurant, you've probably been handed a wet towel. The first time this happens, you'll probably be confused and look to others for guidance on what to do with it.

Generally, it is used to clean your hands. This tradition comes from Japan, where “oshibori” (wet towels) are handed out before meals, to clean hands. In Japanese restaurants, they may be hot or cold, depending on the season. Some people may also use the towels to clean their face.

This tradition has been expanded outside of Japanese restaurants where the practice varies greatly. In Western restaurants, wet towels may be served beforehand/or after the meal—to clean your fingers and around your mouth. According to Etiquette Scholar, it is not polite to clean beyond these areas, such as your neck or behind your ears, in a restaurant.

Many airlines offer wet towels, particularly in first class. They are sometimes offered immediately after takeoff, which is standard in first class on British Airways . . . .” [Why Some Restaurants Provide Wet Towels at Meals—Chad Upton, editor, http://brokensecrets.com/page/18/—Apr. 16, 2011].

In addition, methods to clean oneself after consuming a meal are well-known. For example many restaurants provide table napkins for use during and after a meal. Presently, many fast food restaurants make available to customers paper napkins and wet towelettes for use in cleaning themselves after consuming a meal. Particularly when the consumable food item is potentially sticky or messy, for example a sticky bun, crabs, or chicken wings, use of a napkin or towelette is helpful to reduce the transfer of traces of the food item to other surfaces that the customer may contact.

When one purchases a beverage and/or food item at a convenience store or restaurant, multi-purpose wipes, such as napkins and towelettes, are sometimes separately provided to assist the customer in cleaning up after consuming the food and beverage. If the napkins and towelettes are provided separately in the bag, they may be inadvertently discarded or lost prior to or after consuming the meal. In such a situation, the customer would not have a towelette or napkin to clean himself and would increase the likelihood that food or beverage residues might be transferred to other surfaces. That transfer provides an environment, which becomes more unsanitary and leads to increases in the amount of germs.

### SUMMARY

To avoid that unfortunate situation, the inventor has developed a clean-up system that comprises having one or more multi-purpose wipe packets or generally rectangular packets having a generally rectangular shape as components of a cup sleeve to surround the container of the food item so that the multi-purpose wipe is more readily available to the customer before, during, and after consuming foods and/or beverages, particularly from restaurants or convenience stores that cater to take-out customers. The clean-up system aids in cleaning up germs as it is immediately available to wipe off a surface when one needs it. The clean-up system also eliminates the need for store employees to provide these items separately, thus increasing the productivity of the employees.

An important benefit of the system is that the cup sleeve insulates the user's fingers, when consuming drink or food from a cup containing very hot or very cold beverages. Conventional cup sleeves are typically provided when a hot beverage such as coffee or tea is served in a paper cup. Sometimes a cup sleeve may be used similarly for frozen milkshakes or similar products as well. The present invention is also well-adapted for use with a container for hot soup or chili, or a container for soft-serve frozen custard or the like.

The following patent references describe various cup sleeves known in the art.
U.S. Pat. No. 4,383,422 of GORDON, Jay E. et al. issued 1983 May 17
U.S. Pat. No. 4,462,444 of LARSON, Fred G. issued 1984 Jul. 31
U.S. Pat. No. 5,005,374 of SPITLER, Michael L. issued 1991 Apr. 9
U.S. Pat. No. 5,425,497 of SORENSEN, Jay issued 1993 Nov. 9
U.S. Pat. No. 5,669,553 of SMITH, Ernest L. issued 1997 Sep. 23
U.S. Pat. No. 5,826,786 of DICKERT, James issued 1998 Oct. 27
U.S. Pat. No. 5,842,633 of NURSE, Robert I. issued 1998 Dec. 1
U.S. Pat. No. 6,250,545 of MAZZAROLO, Ugo et al. issued 2001 Jun. 26
U.S. Pat. No. 6,986,438 of LEUNG, Bernard issued 2006 Jan. 17
U.S. Pat. No. 8,627,982 of SELINA, John R. issued 2014 Jan. 14
U.S. Pat. No. 8,668,109 of DICKERT, James C. issued 2014 Mar. 11
U.S. Patent Application 20060000882 of DARZINSKAS, Raymond filed 2006 Jan. 5
U.S. Patent Application 20060186129 of ALLNUTT, Elena G. et al. filed 2006 Aug. 24
U.S. Patent Application 20100224641 of HANEL, Robert Dale filed 2010 Sep. 9
U.S. Patent Application 20120024875 of ZERDA, Deborah A. et al. filed 2012 Feb. 2
U.S. Patent Application 20120285974 of HANEL, Robert Dale filed 2012 Nov. 15
U.S. Patent Application 20140038804 of KONKIN, Barry filed 2014 Feb. 6
Canada Patent CA2822386 of KONKIN, Barry published 2014 Feb. 2
International Patent Application WO2008000041 of KOOLEN INVEST PTY LTD, et al. published 2008 Jan. 3

Various embodiments of the invention are summarized in the following paragraphs.

An embodiment of the invention is an insulating cup sleeve adapted for use with a cup for hot or cold food or beverages, the cup sleeve consisting essentially of a generally rectangular packet containing one or more multi-purpose wipes, wherein the shorter ends of the generally rectangular packet are secured to each other at a juncture to form a generally cylindrical sleeve, the inner circumference of the sleeve being approximately the exterior circumference near the top of the cup with which it is adapted to be used, and wherein the vertical dimension (height) of the sleeve is about 2 to 3 inches. Each generally rectangular packet may contains up to four multi-purpose wipes. In forming the cup sleeve, the shorter ends of the generally rectangular packet may be secured together with a permanent adhesive. Glue may be typically used to secure the ends.

An embodiment of the invention is an insulating cup sleeve wherein the exterior surface of the insulating cup sleeve is textured, whereby the cup sleeve can be readily gripped without slipping from the user's fingers. The exterior surface of the cup sleeve comprised of one or more generally rectangular packet may be comprised of indentations, dimples, pimples, protrusions, raised or engraved lines or grids, or Braille-like dots to produce the textured surface. The exterior surface of the insulating cup sleeve may be imprinted with a message, advertisement, or other text, artwork, designs, marks, symbols, or the like. Additionally, the generally rectangular packet may further comprise an opening means selected from the group of perforations, scoring, zipper-like device, and a fitment opened with the aid of an attached string, filament, or pull-tab, to facilitate access to the multi-purpose wipes therein.

The above-described insulating cup sleeve may further comprise an additional generally rectangular packet containing one or more multi-purpose wipes, wherein one of the shorter ends of the additional generally rectangular packet is secured to the aforesaid juncture, whereby the additional generally rectangular packet wraps fully or partially around the generally cylindrical sleeve, and the other of the shorter ends of the additional generally rectangular packet is removably affixed to the exterior surface of the sleeve, whereby a user who opens the additional (exterior) generally rectangular packet may remove a wet wipe and use it to clean oneself before consuming the contents of the cup, while keeping the contents of the first mentioned (interior) generally rectangular packet fresh for subsequent use. The additional generally rectangular packet may wrap fully around the generally cylindrical cup sleeve, and the other of the shorter ends is removably secured at or near the aforesaid juncture. Alternatively, the additional generally rectangular packet can wrap around about half of the cylindrical sleeve. It may be desirable to have the additional generally rectangular packet be removably secured to the cup sleeve using a temporary securement means such as double-sided tape, glue, Velcro, or other temporary means.

Another embodiment of the invention is a method of using the insulating cup sleeve as described above, comprising the steps of a user:
sliding the bottom of a frusto-conical cup containing a hot or cold drink or food through the top circular opening of the cup sleeve until the cup sleeve embraces the cup;
gripping the cup sleeve while consuming drink or food from the cup;
removing the cup sleeve from the cup and opening the generally rectangular packet from which the cup sleeve is formed to expose the multi-purpose wipe; and
removing the multi-purpose wipe from the opened generally rectangular packet for use in cleaning oneself.

An alternative embodiment of the invention is an insulating cup sleeve adapted for use with a cup for hot or cold food or beverages, the cup sleeve consisting essentially of two generally rectangular packets each containing one or more multi-purpose wipes, wherein a first shorter end of a first of the generally rectangular packets is secured together to a first shorter end of a second of the generally rectangular packets, and the second shorter end of the first of the generally rectangular packets is secured together to the second shorter end of the second of the generally rectangular packets to form a generally cylindrical sleeve, the inner circumference of the sleeve being approximately the exterior circumference near the top of the cup with which it is adapted to be used, and wherein the vertical dimension (height) of the sleeve is about 2 to 3 inches, whereby a user who opens the first generally rectangular packet may remove a wet wipe and use it to clean oneself before consuming the contents of the cup, while keeping the contents of the second generally rectangular packet fresh for subsequent use.

In forming the insulating cup sleeve of this embodiment, the shorter ends of the generally rectangular packet may be secured together with a permanent adhesive. Glue may be typically used to secure the ends. The exterior surface of the insulating cup sleeve may be textured, whereby the cup sleeve can be readily gripped without slipping from the user's fingers. The surface of the cup sleeve, comprised of one or more generally rectangular packet, may be comprised of indentations, dimples, pimples, protrusions, raised or engraved lines or grids, or Braille-like dots to produce the textured surface. The exterior surface of the insulating cup sleeve may be imprinted with a message, advertisement, or other text, artwork, designs, marks, symbols, or the like. Additionally, the generally rectangular packet may further comprise an opening means selected from the group of perforations, scoring, zipper-like device, and a fitment opened with the aid of an attached string, filament, or pull-tab, to facilitate access to the multi-purpose wipes therein.

An embodiment of the invention is a method of using the insulating cup sleeve as described above, comprising the steps of:
sliding the bottom of a frusto-conical cup containing a hot or cold drink through the top circular opening of the insulating cup sleeve until the cup sleeve embraces the cup;
opening the additional generally rectangular packet containing one or more multi-purpose wipes for use in cleaning oneself, while keeping the contents of the generally rectangular packet fresh for subsequent use;
gripping the cup sleeve while drinking from the drink container;
removing the insulating cup sleeve from the cup and opening the generally rectangular packet from which the cup sleeve is formed to expose the multi-purpose wipe; and
removing the multi-purpose wipe from the opened generally rectangular packet for use in cleaning oneself.

Another embodiment of the invention is an insulating telescopic cup sleeve adapted for use with a cup for hot or cold food or beverages, the telescopic cup sleeve comprising two nested cup sleeves each consisting essentially of a generally rectangular packet, wherein the shorter ends of each generally rectangular packet are secured to each other at a juncture to form a generally cylindrical sleeve, the inner circumference of the outer cup sleeve being approximately the exterior circumference near the top of the cup with which it is adapted to be used, the outer circumference of the inner cup sleeve being slightly less than the inner circumference of the outer cup sleeve, wherein the vertical dimension (height) of the each cup sleeve is about 1 to 3 inches, and wherein the nested cup sleeves are affixed to a cup for hot or cold food or beverages, wherein the outer cup sleeve may be telescoped up from the inner cup sleeve onto the cup until the outer cup sleeve embraces the cup, thereby forming the telescoped cup sleeve, and wherein the generally rectangular packet may consist of one multi-purpose wipe packet or multiple serially-connected multi-purpose wipe packets, each containing one or more multi-purpose wipes. The shorter ends of each generally rectangular packet may be secured together with a permanent adhesive such as glue.

The exterior surface of each nested cup sleeve may be textured, whereby each of the nested cup sleeves can be readily gripped without slipping from the user's fingers. The textured exterior surface of each nested cup sleeve may comprise indentations, dimples, pimples, protrusions, raised or engraved lines or grids, or Braille-like dots. The exterior surface of each generally rectangular packet may be imprinted with a message, advertisement, or other text, artwork, design, mark, symbol, or the like. Additionally, the generally rectangular packet comprising the telescopic cup sleeve may further comprise an opening means selected from the group of perforations, scoring, zipper-like device, and a fitment opened with the aid of an attached string, filament, or pull-tab, to facilitate access to the multi-purpose wipes therein.

The insulating telescopic cup sleeve may further comprising a band ring comprised of paper, plastic, or a synthetic material, and having a quick-release attachment means for holding the nested cup sleeves together on the cup until the quick-release attachment means is opened to allow the outer cup sleeve to be telescoped up from the inner cup sleeve onto the cup until the outer cup sleeve embraces the cup, thereby forming the telescoped cup sleeve, wherein the band ring is affixed to the cup. The quick-release attachment means may consists of a non-permanent adhesive or may be formed of double-sided adhesive tape.

An embodiment of the invention is a method of using the insulating telescopic cup sleeve, comprising the steps of a user:
sliding the bottom of a frusto-conical cup containing a hot or cold drink or food through the top circular opening of the two nested cup sleeves until the inner cup sleeve embraces the cup;
telescoping the outer cup sleeve up from the inner cup sleeve onto the cup until the outer cup sleeve embraces the cup, thereby forming the telescoped cup sleeve;
gripping the telescoped cup sleeve while consuming drink or food from the cup;
removing the inner cup sleeve from the cup and opening the generally rectangular packet from which the cup sleeve is formed to expose the multi-purpose wipe; and
removing the multi-purpose wipe from the opened generally rectangular packet for use in cleaning oneself.

A further embodiment of the invention is a method of using the insulating telescopic cup sleeve having a band ring, comprising the steps of a user:
sliding the bottom of a frusto-conical cup containing a hot or cold drink or food through the top circular opening of two nested cup sleeves bound by a band ring until the nested cup sleeves embrace the cup;
opening quick-release attachment means of the band ring;
telescoping the outer cup sleeve up the opened band ring from the inner cup sleeve onto the cup until the outer cup sleeve embraces the cup, thereby form the telescoped cup sleeve;
gripping the telescoped cup sleeve while consuming drink or food from the cup;
removing the inner cup sleeve from the cup and opening the generally rectangular packet from which the cup sleeve is formed to expose the multi-purpose wipe; and
removing the multi-purpose wipe from the opened generally rectangular packet for use in cleaning oneself.

Another embodiment of the invention is a wrapped insulating cup sleeve adapted for use with a cup for hot or cold food or beverages, the cup sleeve formed from one generally rectangular packet, wherein the length of the packet is greater than the exterior circumference near the top of the cup with which it is adapted to be used, wherein the vertical dimension, or height, of the sleeve is about 2 to 3 inches, wherein the packet has a strip of adhesive or tape having a protective means affixed to the inner surface, wherein removal of the protective means allows the user to wrap the generally rectangular packet around a cup and the adhesive binds the generally rectangular packet both to the cup and to itself forming the wrapped insulating cup sleeve, and wherein said generally rectangular packet consists of a single packet, or two or more serially-attached packets, each containing one or more multi-purpose wipes. Generally for this embodiment, the rectangular packet is at least twice the circumference near the top of the cup with which it is adapted to be used, and wherein a double-layer insulating cup sleeve is formed. The adhesive may be a non-permanent adhesive.

An embodiment of the invention is a method of using the wrapped insulating cup sleeve described above, comprising the steps of a user;
removing the protective means from the strip of adhesive or tape affixed to the inner surface of the generally rectangular packet;
wrapping the generally rectangular packet around the cup to form the wrapped insulating cup sleeve;
gripping the wrapped insulating cup sleeve while consuming drink or food from the cup; and
opening the generally rectangular packet and removing a multi-purpose wipe from the opened generally rectangular packet for use in cleaning oneself.

### BRIEF DESCRIPTION OF THE DRAWINGS

FIG. 1 is a perspective view of an embodiment of a cup sleeve of the present invention, which is formed by two generally rectangular packets, around (embracing) a frusto-conical cup.

FIG. 2 is a perspective view of an embodiment of the invention showing a cup sleeve formed from one generally rectangular packet, around a cup.

FIG. 3 is a perspective view of an embodiment of the invention showing a cup sleeve comprising a generally rectangular packet around a cup and having additional multi-purpose wipe packets attached thereto, providing easy detachment of the additional packets without disrupting the integrity of the sleeve.

FIG. 4 is a perspective view of an alternative embodiment of the invention showing a cup sleeve around a cup, providing an additional multi-purpose wipe packet that is removably attached to the sleeve.

FIG. 5a is a perspective view of an embodiment of the invention showing a generally cylindrical cup sleeve formed from a generally rectangular packet, containing one or more multi-purpose wipes, wherein the outer surface of the generally rectangular packet further has protrusions or pimples that aid in gripping the cup sleeve and cup.

FIG. 5b is a perspective view of an embodiment of the invention showing a cup sleeve formed from a generally rectangular packet containing one or more multi-purpose wipes, wherein the outer surface of the generally rectangular packet further has indentations or dimples that aid in gripping the cup sleeve and cup.

FIG. 5c is a perspective view of an alternative embodiment of the invention showing a cup sleeve formed from a generally rectangular packet containing one or more multi-purpose wipes, wherein the outer surface of the generally rectangular packet further has raised grid lines that aid in gripping the cup sleeve and cup.

FIG. 6 is a perspective view of an embodiment of the invention showing a cup sleeve formed from a single generally rectangular packet surrounding a beverage cup and further having individual multi-purpose wipe packets connected serially and detachably to the cup sleeve.

FIG. 7a is an elevation view of a packet containing a multi-purpose wipe, which is imprinted with a design.

FIG. 7b is an elevation view of a packet containing a multi-purpose wipe.

FIG. 8 is a top view of an embodiment of the invention formed from two generally rectangular packets, shown in use around a frusto-conical cup.

FIG. 9 is a top view of a sleeve embodying the present invention formed from a single generally rectangular packet, containing two multi-purpose wipes, shown in use around a frusto-conical cup.

FIG. 10 is an elevation view of a generally rectangular packet detached from the embodiment of the invention show in FIG. 2 and flattened out.

FIG. 11a is a perspective view of an alternative embodiment of the invention showing a cup and an insulating telescopic cup sleeve formed from two nested cup sleeves each comprising a generally rectangular packet containing one or more multi-purpose wipes.

FIG. 11b is a perspective view of the alternative embodiment shown in FIG. 11a showing a cup and an insulating telescopic cup sleeve wherein the formerly nested cup sleeves are telescoped up onto the body of the cup.

FIG. 11c is a perspective view of the alternative embodiment shown in FIGS. 11a and 11b showing a cup and an insulating telescopic cup sleeve wherein the lower cup sleeve of the cup sleeve has been removed for usage.

FIG. 11d is a perspective view showing usage of a multi-purpose wipe that has been taken from the removed lower cup sleeve of the alternative embodiment shown in FIG. 11b and FIG. 11c to clean the mouth and face of a user.

FIG. 11e is a perspective view showing usage of a multi-purpose wipe that has been taken from the removed lower cup sleeve of the alternative embodiment shown in FIG. 11b and FIG. 11c to clean an automobile steering wheel.

FIG. 12a is a perspective view of an alternative embodiment of the invention showing a cup and an insulating telescopic cup sleeve formed from two nested cup sleeves each comprising a generally rectangular packet containing one or more multi-purpose wipes. The nested cup sleeves are secured together with a band ring

FIG. 12b is a perspective view of the alternative embodiment shown in FIG. 12a showing a cup and an insulating telescopic cup sleeve formed from two nested cup sleeves each comprising a generally rectangular packet containing one or more multi-purpose wipes. The band ring securing the nested cup sleeves is open allowing for one of the cup sleeves to be telescoped up on the cup.

FIG. 12c is a perspective view of the alternative embodiment shown in FIGS. 12a and 12b showing an insulating telescopic cup sleeve wherein the cup sleeves are shown telescoped up onto the body of the cup by opening the ring band.

FIG. 13a is a perspective view of an alternative embodiment of the invention showing a cup and a generally rectangular packet containing one or more multi-purpose wipes for attachment to the cup. The generally rectangular packet has an adhesive strip on one of its sides.

FIG. 13b is a perspective view of the alternative embodiment shown in FIG. 13a wherein the generally rectangular packet containing one or more multi-purpose wipes and having an adhesive strip on the inner side in the process of being applied to a cup by contacting the adhesive strip to the cup to form the insulating cup sleeve.

FIG. 13c is a perspective view of the alternative embodiment shown in FIGS. 13a and 13b wherein the insulating cup sleeve is formed by wrapping the generally rectangular packet containing one or more multi-purpose wipes around the cup and is attached to the cup and a portion of itself by the adhesive strip (not shown).

### DETAILED DESCRIPTION

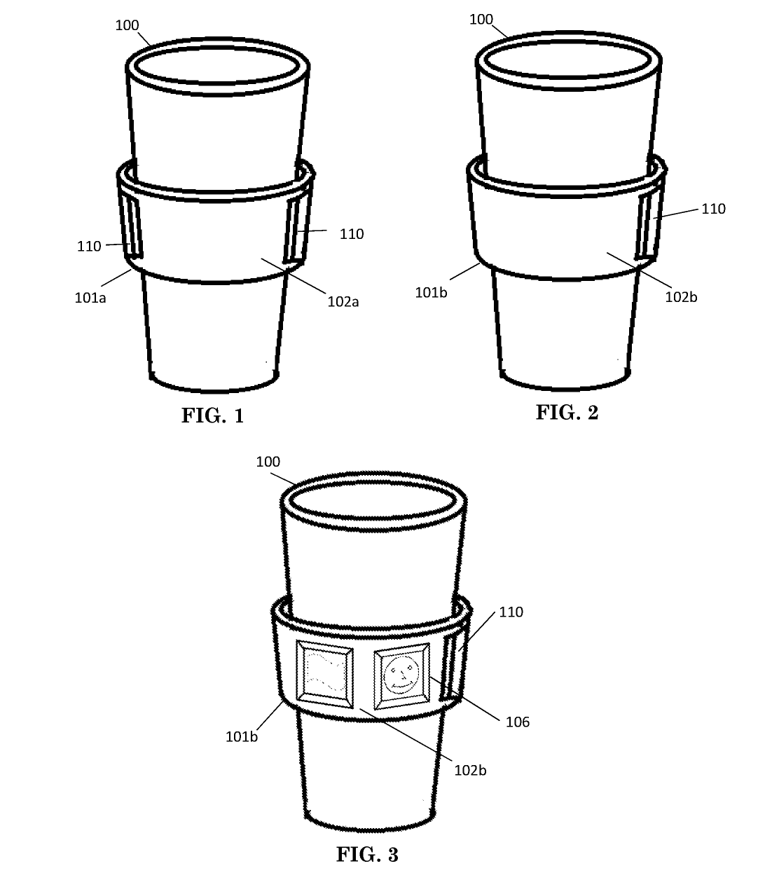

An embodiment of the invention is an insulating cup sleeve made up of two generally rectangular packets, each containing one or more multi-purpose wipes such as towelettes, napkins, or other sanitary wipes, wherein the generally rectangular packets are serially joined together at their ends to form the cup sleeve. The packets may be adhesively bonded to each other using a permanent adhesive such as glue or other adhesive means. Alternatively, the two packets can be mechanically joined together during production forming the sleeve. An example of this embodiment is shown in FIG. 1.

In general, for any of the embodiments, the ends of the generally rectangular packets can be attached or joined together by any of various well-known methods such as stapling, gluing, taping, interlocking, or other attaching means to form a seam or juncture.

An alternative embodiment of the invention is an insulating cup sleeve comprised of one generally rectangular packet containing one or more multi-purpose wipes such as towelettes, napkins, or other sanitary wipes, wherein the ends of the generally rectangular packet are joined to form the cup sleeve. The ends of the generally rectangular packet may be adhesively bound together using a permanent adhesive such as glue or other adhesive means. Alternative, the ends can be mechanically joined together during production forming the sleeve. An example of this embodiment is shown in FIG. 2.

A further embodiment of the invention is an insulating cup sleeve comprised of one or two generally rectangular packets and further having separate multi-purpose wipe packets and the like removably attached thereto. Each multi-purpose wipe packet may be affixed to the cup sleeve by a temporary adhesive means such as double-sided tape, glue, hook and loop tape such as Velcro, or other temporary adhesive means, so that the cup sleeve retains its form and position on the cup when a packet is removed, opened, and used. An example of this embodiment is shown in FIG. 3.

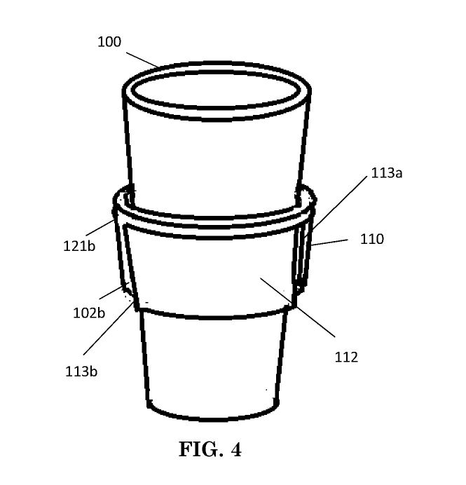

An embodiment of the invention is an insulating cup sleeve comprised of at least two generally rectangular packets having a total horizontal dimension or length that is greater than the circumference of the cup at the top. The sleeve portion of the cup sleeve is formed by permanently adhering together one end of a first packet, having a horizontal length approximately equal to the circumference of the top of the cup, to itself to form the seam of the resulting cup sleeve. The excess remaining portion extending out from the seam, comprised of an additional generally rectangular packet, is then removably or temporarily adhered to the surface of the cup sleeve with a temporary adhesive such as double-sided tape, glue, Velcro, or other temporary adhesive means. The additional multi-purpose wipe packet may have one or more multi-purpose wipes contained therein. Furthermore, the additional generally rectangular packet may have a length equal to or less than the circumference of the top of the cup. Thus, the additional generally rectangular packet may completely surround the cup sleeve if its horizontal dimension or length is about the same as the circumference of the sleeve. Alternatively, if the length of the additional generally rectangular packet is less than the exterior circumference of sleeve, it will overlap only a portion of the cup sleeve. It is preferred that when the length of the additional generally rectangular packet is less than the circumference of the sleeve, the horizontal dimension (length) of the additional generally rectangular packet be about half of the circumference of the sleeve, so that it overlaps about half of the cup sleeve. An example of this embodiment is shown in FIG. 4.

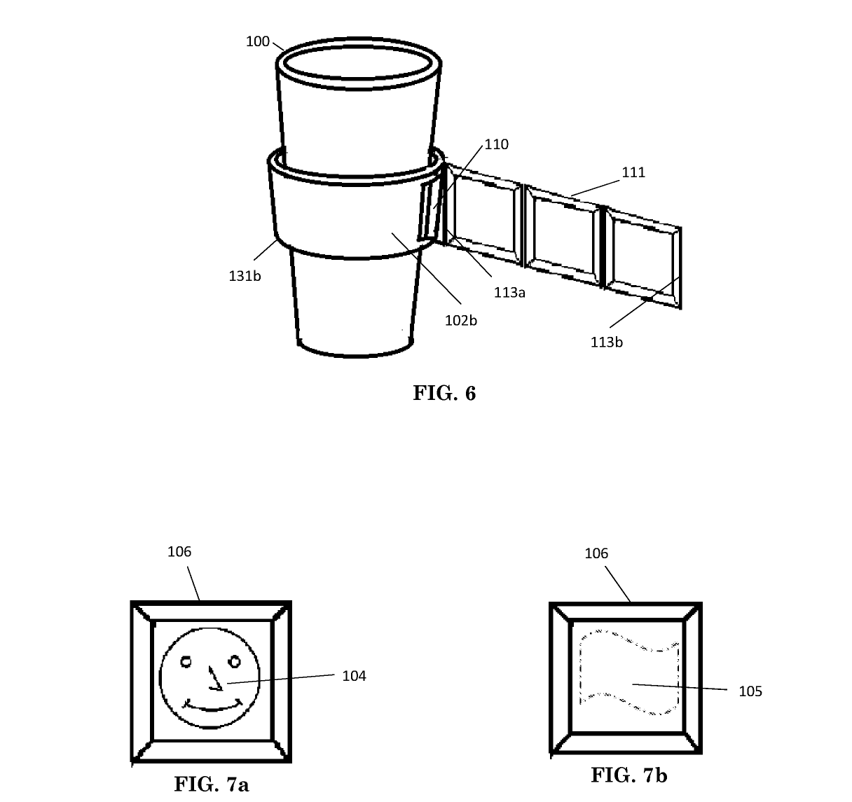

Other embodiments of the invention involve an insulating cup sleeve comprised of one or more generally rectangular packets each containing one or more towelettes, napkins, or other sanitary wipes. In these embodiments, the cup sleeve further has connected to it one or more detachable individual-multi-purpose wipe packets in series, allowing for the user to use remove a serially attached individual-multi-purpose wipes packet for use without disturbing the integrity of the cup sleeve. A series of individual-multi-purpose wipe packets may be connected to the cup sleeve at the seam or any other location of the cup sleeve. An example of these embodiments is shown in FIG. 6.

The generally rectangular packet contains one or more multi-purpose wipes such as towelettes, napkins, or other sanitary wipes. The multi-purpose wipe may be in sections that can be torn off so as to use separate sections for wiping. The multi-purpose wipe could be used to clean the fingers, hand, mouth, or face of an adult, child, or baby. Alternatively the multi-purpose wipe could be used to clean surfaces where the beverage and/or food item is consumed. For example, in an automobile such surfaces would include the instrument panel, dash board, steering wheel, door handles, seat, and the like. Or, the multi-purpose wipe could be used to clean spills on the customer's clothing such as pants, shirts, blouses, sport coats, skirts, and dresses. Alternatively, if desired, the multi-purpose wipe could be used to clean a pet or the pet's mouth.

The multi-purpose wipe may be a towelette, napkin, or other sanitary wipe. The multi-purpose wipe may be constructed of a material such as woven or non-woven materials including webs comprising man-made and natural fibers, such as polyolefin fibers, viscose fibers, and cotton fibers.

The wipe may be dry (as a napkin) or moist (as a towelette) and may be treated with a disinfecting or sanitizing agent, either to provide a sterile napkin or more commonly, a moist towelette. Sanitizing agents that may be applied to such wipes include, but are not limited to, quaternary ammonium chlorides, alcohols, glutaraldehydes, iodine solutions, parabens, peroxides, and peracids. Examples of disinfecting or sanitizing agents typically applied to sanitizing wipes are disclosed in U.S. Pat. No. 7,288,513 of TAYLOR, Paul et al issued 2007 Oct. 30; U.S. Pat. No. 8,563,017 of CUNNINGHAM, Corey et al issued 2013-1022; and European Patent 1059032 of PICCINI, Andrea et al published 2000 Dec. 13.

The multi-purpose wipe can be a large wipe that can be cut, torn or otherwise divided into two or more sections. Embodiments of the present invention may provide more than one kind of multi-purpose wipe to the user, e.g. both a towelette and a napkin.

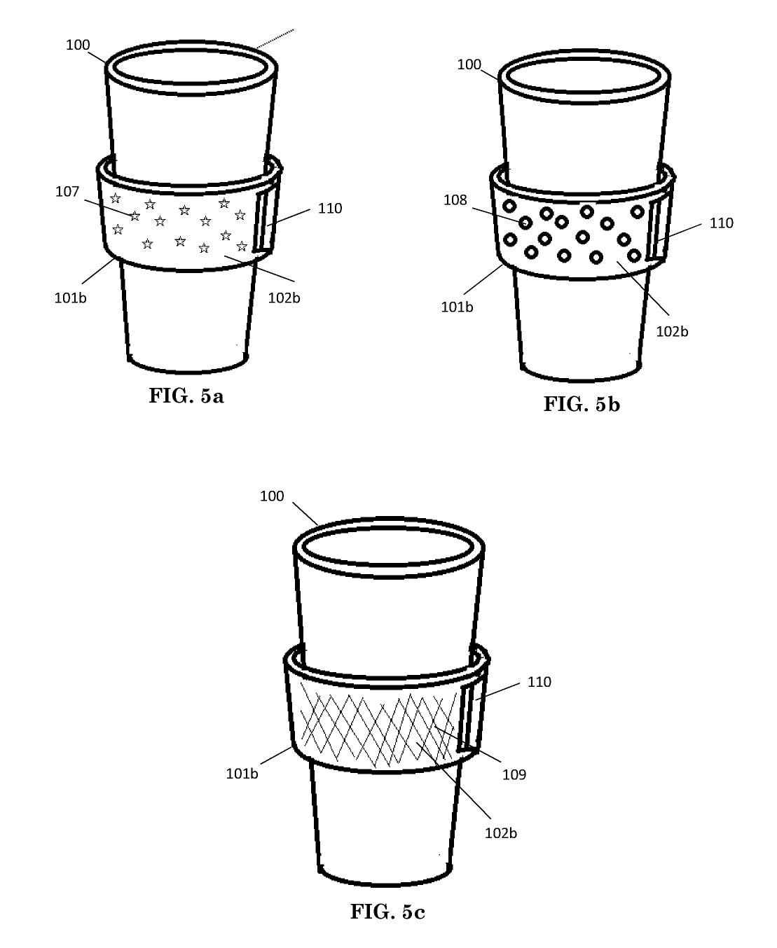

The outer surface of the generally rectangular packet may be smooth or textured. Textured surfaces have the advantage of aiding a user to grip the cup sleeve, preventing slippage of the cup. Examples of a textured outer surface of a packet include dimples or indentations in the surface. Typical textured surfaces may include pimples, protrusions, raised lines or grids, or Braille-like dots on the outer surface of a packet. Textured surfaces also aid in griping the cup sleeve. Examples of textured surfaces are shown in FIGS. 5a, 5b, and 5c.

The generally cylindrical cup sleeve of the present invention should have a vertical dimension, or width, that is extensive enough to allow a user to grip the cup sleeve and not contact the cup directly. For example, the vertical dimension can be between about 2 and 3 inches. Preferably the width is about 2.5 inches.

The generally cylindrical cup sleeve of the present invention should have an inner circumference that matches the outer circumference near or at the top of the cups with which it is adapted to be used. For embodiments wherein the sleeve is formed by a generally rectangular packet of multi-purpose wipes, the horizontal dimension, or length, of the packet matches the outer circumference near or at the top of such cups. Alternatively, if the cup sleeve is comprised of two generally rectangular packets, each packet should have a horizontal dimension that is about half of the circumference near the top of such cups.

Various hand-held cups for use with the invention will typically have a circumference of about 7 to 13 inches at the top of the cup. Many cups for such use have a circumference of about 11 inches at the top of the cup. It's desirable for the top of the sleeve to match the circumference of the cup a bit below the very top, e.g. about an inch below. Preferred embodiments of the present invention are sized to provide a cylindrical sleeve having an inner circumference of about 10 inches.

The depth or thickness of the generally rectangular packet forming the cup sleeve is dependent upon these factors: the thickness of the packet surface material and the folding of the multi-purpose wipe enclosed therein. It is desirable that the packet be thick enough to provide insulation against the contents of the cup, yet not so thick as to impair gripping of the cup and cup sleeve. As the present invention provides a cylindrical sleeve, it is to be understood that the bottom of the sleeve will allow clearance, a gap, between its inner circumference and the outer circumference of the frusto-conical cup. In balancing the aforesaid factors when deciding the configuration of specific packets for a particular embodiment of the invention, this fact is desirably taken into account.

For the embodiment of the invention shown in FIG. 2, the cup sleeve is formed by adhesively bonding the ends 114 of a single generally rectangular packet 102b as shown in FIG. 10 together with glue or other adhesive means. A suitable adhesive for forming the cup sleeve would provide a more or less permanent binding of the ends together. Typical adhesive for permanently binding the multi-purpose wipe packet together include, but is not limited to, permanent glues, or epoxy-based or acrylate-based adhesives. Alternatively, a cup sleeve formed from two generally rectangular packets, as shown in FIG. 1, would have each end of the packets adhesively bound together in series to form the cup sleeve. It is preferred that the bonded portions of the cup sleeve be as flat as possible so as not to interfere with a user's gripping of the cup sleeve.

Individual—generally rectangular packets and the additional multi-purpose wipe packets can be removably adhered to the cup sleeve, as shown for example in FIG. 3, using non-permanent adhesive means such as double-sided removable tape, a temporary glue, Velcro, or a gum. The adhesive used for Post-It® removable products of 3M is an example, and various removable adhesives are available under various brand names from 3M, St. Paul, Minn.

Methods of making strips or rolls of packaged towelettes and napkins are conventionally known. For example, U.S. Pat. No. 3,930,350 of REID, Philip L. issued 1976 Jan. 6 and the references cited therein disclose methods and apparatuses for packaging one or more products, for example towelettes, in a sealed package. This reference also discloses materials used to fabricate the packets such as polyethylene coated with ethylene vinyl acetate interpolymer and laminates such as those including a barrier layer such as poly(vinylidene chloride).

Generally, it is desirable to have a packet constructed of a material that is relatively airtight so that a moist wipe inside does not dry out. It is known in the art to use materials including plastic films, thermoplastics, heat-sealable materials, coated papers, foil-lined materials, and other synthetic materials. See for example U.S. Pat. No. 7,943,165 of DONEY, Mindee K. et al issued 2011 May 17. Packets for multi-wipes are commercially available from manufacturers including Pacon Manufacturing, Somerset, N.J., USA; Diamond Wipes International, Inc. Chino, Calif., USA; Alcan Packaging, Cumbria, Calif., USA; and Wrapper India, Mumbai, Maharashtra, India;

It is a desirable feature of the invention that the generally rectangular packets may be imprinted with messages, advertisements, artwork, designs, marks, symbols, or other text. An example of an imprinted towelette packet is shown as packet 106 in FIGS. 3 and 7a. Note that the packets forming the cup sleeve itself, e.g. packet 101a and 102b, are desirably also imprinted.

It is an embodiment of the invention that each rectangular packet is adapted with a means to easily access the multi-purpose wipe enclosed therein. For example the rectangular packet may have perforations or scoring on the surface that allows a user to easily open the packet to access the multi-purpose wipes. Alternatively, the rectangular packet may have a zipper-like re-closeable fitment that can be opened to facilitate access to the multi-purpose wipes and subsequently reclosed. Alternatively, the rectangular packet may have a fitment that may be opened with the aid of an attached string, filament, or pull-tab made of a natural or synthetic material or blends thereof.

The rectangular packet may be made of a translucent material either partially or fully making the enclosed multi-purpose wipe visible to a user. The rectangular packet may have laminated designs or features incorporated thereon to suggest the appearance of other materials and can be of any color or no color. Designs or messages may be displayed on the surface of the rectangular packet.

It is an advantage of the invention that the cup sleeve as positioned around a cup, prevents injuries such as burns or occasionally frostbite to fingers or other body parts, because of the insulating effect of the cup sleeve.

Suitable cups for use with the cup sleeve include beverage cups, coffee cups, soup cups, ice cream cups, hot/cold drink cups, or other cup-like food containers.

Another aspect of the invention is a method of using the inventive cup sleeve comprising the steps of a user:
(a) sliding the bottom of a frusto-conical cup containing a hot or cold drink or food through the top circular opening of the cup sleeve until the cup sleeve embraces the cup;
(b) gripping the cup sleeve while consuming drink or food from the cup;
(c) removing the cup sleeve from the cup and opening the generally rectangular packet from which the cup sleeve is formed to expose the multi-purpose wipe; and
(d) removing the multi-purpose wipe from the opened generally rectangular packet for use in cleaning oneself.

As described above, some embodiments of the inventive cup sleeve provide immediate access to one or more multi-purpose wipe packets for use before the contents of the cup are consumed. Accordingly, it is another aspect of the invention to provide a method of using such a cup sleeve, comprising the steps of:
(a) sliding the bottom of a frusto-conical cup containing a hot or cold drink through the top circular opening of the cup sleeve having attached an additional packet containing one or more multi-purpose wipes until the cup sleeve embraces the cup;
(b) gripping the cup sleeve while drinking from the drink container;
(c) opening the additional packet containing one or more multi-purpose wipes for use in cleaning oneself, while keeping the contents of the cup sleeve generally rectangular packet fresh for subsequent use;
(d) removing the cup sleeve from the cup and opening the g generally rectangular packet from which the cup sleeve is formed to expose the multi-purpose wipe; and
(e) removing the multi-purpose wipe from the opened generally rectangular packet for use in cleaning oneself.

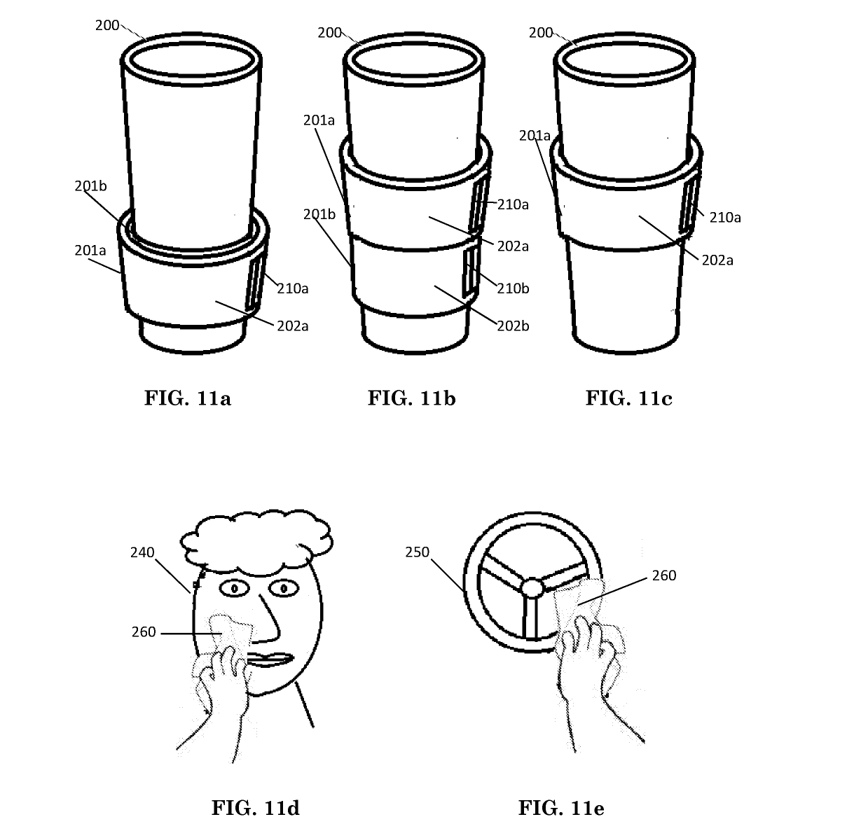

An alternative embodiment of the invention is an insulating telescopic cup sleeve comprising two or more nested cup sleeves on a cup for hot or cold food or beverages. Each of the nested cup sleeves should be of an appropriate size to allow both nesting of the cup sleeves and attachment of the nested cup sleeves to at least the base of the cup. The nested cup sleeves of this embodiment may be telescoped on the cup to cover a larger area of the cup by moving, sliding, or expanding the outer cup sleeves up from the inner cup sleeves until the outer cup sleeves embrace the cup, thereby forming the telescoped cup sleeve. The telescoped cup sleeve provides additional insulating effects to the cup. Alternatively, the lower cup sleeves may be removed, leaving the upper cup sleeves in place for continued use as an insulating cup sleeve. The removed cup sleeves can then be opened and the enclosed multi-purpose wipes used as needed. For example, the multi-purpose wipes may be used to clean the fingers, hand, mouth, or face of an adult, child, or baby; clean surfaces where a beverage and/or food item is consumed; clean automobile surfaces, such as the instrument panel, dash board, steering wheel, door handles, seat, and the like; clean spills on clothing including pants, shirts, blouses, sport coats, skirts, and dresses; or clean a pet or the pet's mouth. Alternatively, the user may retain the removed cup sleeve for future use. It is a preferred embodiment that the insulating telescopic cup sleeve comprises two nested cup sleeves as exemplified in FIGS. 11a and 11b.

The cup sleeves of the telescopic cup sleeve can be prepared by adhesively bonding, with glue or other adhesive means, the shorter ends of each generally rectangular packet to each other at a juncture to form a generally cylindrical sleeve. A suitable adhesive for forming the cup sleeve would provide a more or less permanent binding of the ends together. Typical adhesive for permanently binding the multi-purpose wipe packet together include, but is not limited to, permanent glues, or epoxy-based or acrylate-based adhesives. It is preferred that the bonded portions of the cup sleeve be as flat as possible so as not to interfere with a user's gripping of the cup sleeve. The cup sleeves may be formed on a foam-like conical device such as a FloraCraft® Styrofoam® cone available from an arts and craft store such as Michael's. The cup sleeves may be further flattened with a press prior to use for easier gripping.

The inner circumference of the outer-most cup sleeve being approximately the exterior circumference near the top of the cup with which it is adapted to be used, the outer circumference of each successive inner nested cup sleeve being slightly less than the inner circumference of the next outer cup sleeve. The vertical dimension (height) of the each cup sleeve is about 1 to 3 inches. Each generally rectangular packet may consist of one multi-purpose wipe packet or multiple serially-connected multi-purpose wipe packets, each containing one or more multi-purpose wipes.

The terms telescope, telescoped, and telescoping are intended to mean the un-nesting of cup sleeves on the cup so that they cover a wider area of the cup for insulating purposes. Telescoping up can mean to expand, extend, slide, or otherwise move a cup sleeve up the cup. When a user is gripping a telescoped sleeve, the hand may contact one or multiple cup sleeves.

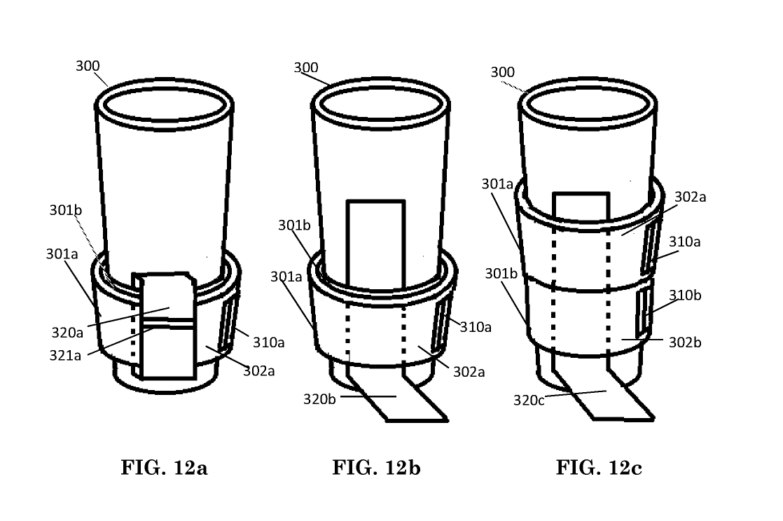

An alternative embodiment of the insulating telescopic cup sleeve is to incorporate a ring band around the nested cup sleeves. The ring band comprises a quick-release attachment means to allow the ring band to keep the nested cup sleeves together and further comprises a cup-sealing means to affix the ring band to the cup. The quick-release attachment means is opened to allow the nested cup sleeves to be telescoped on the cup to cover a larger area of the cup by moving, sliding, or expanding the outer cup sleeves up from the inner cup sleeves until the outer cup sleeves embrace the cup, thereby forming the telescoped cup sleeve. The opened ring band also serves as a guide for telescoping the nested cup sleeves on the cup. This embodiment is exemplified in FIGS. 12a, 12b, and 12c.

The ring band can be of plastic, paper, or a synthetic material that could be affixed either permanently or removably to the cup with a cup sealing means such as double-sided tape, glue, or other adhesive means. It is preferred that the cup sealing means be more permanent to better secure the ring band to the cup. The ring band would further comprise a quick-release attachment mean to allow the ring band to keep the nested cup sleeves affixed to the cup. The ring band quick-release attachment means could be double-sided tape, glue, or other adhesive means. It is preferred that the quick-release attachment means is non-permanent to allow for easy opening of the ring band so that the nested cup sleeves may be telescoped onto the cup.

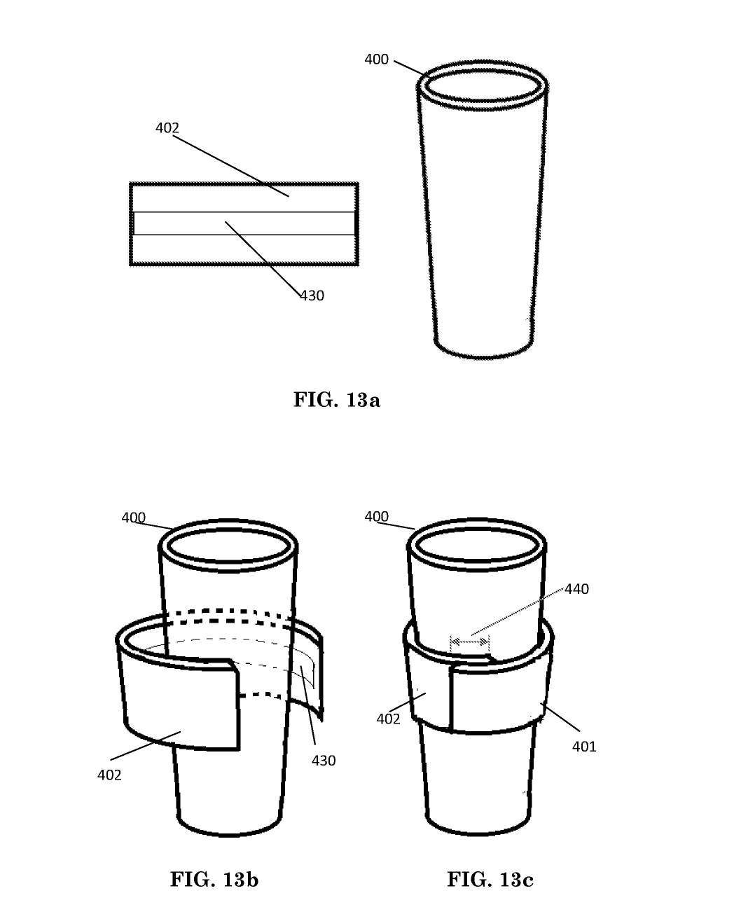

Another embodiment of the invention is a wrapped insulating cup sleeve formed from one generally rectangular packet having an adhesive strip with a removable protective strip on its inner surface. After removal of the protective strip, the user may wrap the generally rectangular packet around the cup and the adhesive strip would attach the packet to the cup and to itself to form the wrapped insulating cup sleeve. Referring to FIG. 13c, the amount of overlap of the generally rectangular packet is indicated by distance 440. The amount of overlap 440 of the generally rectangular packet forming the sleeve may be up to a length equal to the circumference at the top of the cup. An advantage of this embodiment is that it allows for the formation of wrapped insulating cup sleeves suitable for various sizes of cups. This embodiment is exemplified by FIG. 13c.

The length of the generally rectangular packet is greater than the circumference at the top of the cup. It is preferred that the length is at least twice the circumference of the top of the cup. The vertical dimension (height) of the each cup sleeve is about 2 to 3 inches. Each generally rectangular packet may consist of one multi-purpose wipe packet or multiple serially-connected multi-purpose wipe packets, each containing one or more multi-purpose wipes. The adhesive strip could be removable poster tape, double-sided tape, glue, or other adhesive means. It is preferred that the adhesive strip have a removable protective strip over it to prevent the undesired attachment of the generally rectangular packet to other surfaces prior to use.

As will be clear from the present disclosure, the inventive device and method disclosed can be adapted for use with a variety of food or beverage cups, including hot/cold drink cups, beverage cups, soup cups, ice cream cups, and other cup-like food or beverage containers.

For further understanding of various embodiments of the invention, attention is now directed to the drawing figures, where like or corresponding numerals indicate like or corresponding components.

As shown in FIG. 1, a cup sleeve 101a of the present invention is formed from a pair of generally rectangular packets 102a; each packet contains within one or more multi-purpose wipes. The generally rectangular packets 102a together constitute a cylindrical-shaped cup sleeve 101a, adapted as discussed above to embrace the circumference of a drink cup 100. The generally rectangular packets 102a are joined together at each end of the packets to form seams 110 of cup sleeve 101a.

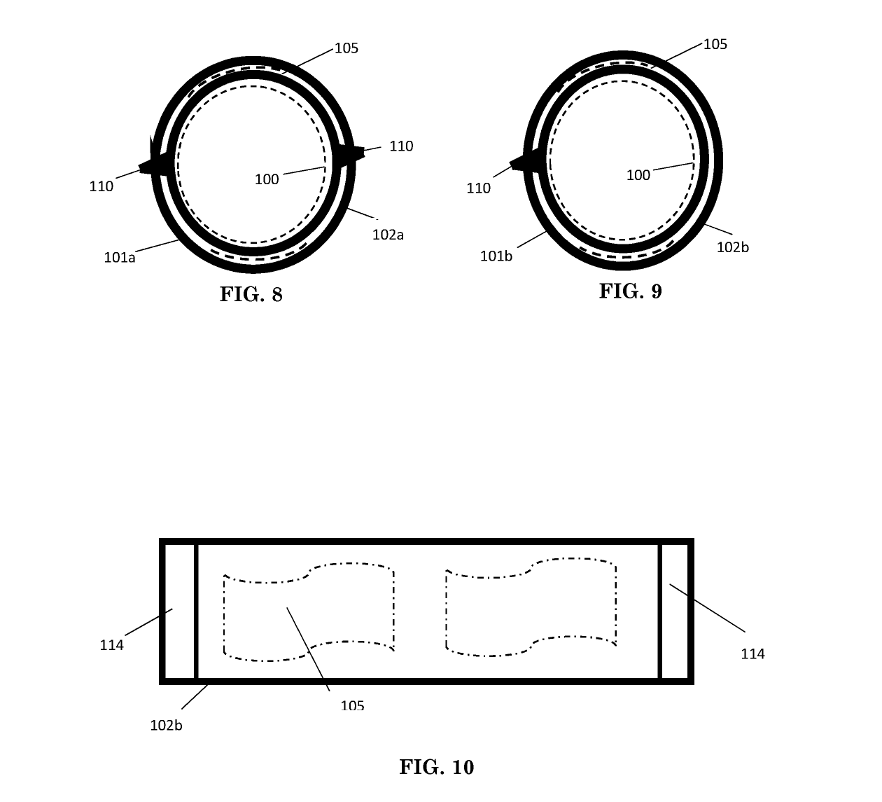

FIG. 8 shows the same embodiment from the top, wherein a cup 100 is shown in dashed lines, and two multi-purpose wipes 105 contained in generally rectangular packets 102a are depicted by dashed lines.

As shown in FIG. 2, an alternative embodiment of the invention provides a cup sleeve 101b formed into a cylindrical shape from a single generally rectangular packet 102b, containing one or more multi-purpose wipes. As shown in FIG. 10, wipe packet 102b is rectangular in overall shape, the longer sides of which approximate the circumference of the cylindrical shape. The shorter sides of packet 102b border the ends of the packet 114. The ends 114 are joined together to form seam 110 of cup sleeve 101b.

FIG. 9 shows the same embodiment from the top, wherein a cup 100 is shown in dashed lines, and two multi-purpose wipes 105 contained in generally rectangular packet 102b are depicted by dashed lines.

FIGS. 5a, 5b, and 5c show variations of the embodiment of FIGS. 2 and 9. In FIG. 5a, one or both of the surfaces of the generally rectangular packet 102b have protrusions or pimples 107 that aid the user in gripping the cup sleeve 101b and/or aid the cup sleeve 101b in gripping the cup 100. In FIG. 5b, one or both of the surfaces of packet 102b have indentations or dimples 108 that aid in gripping the cup sleeve 101b and/or the cup 100. In FIG. 5c, one or both of the surfaces of the packet 102b have raised grid lines 109 that aid in gripping the cup sleeve 101b and/or cup 100.

FIG. 3 shows an embodiment of the invention wherein a cup sleeve 101b formed by a generally rectangular packet 102b depicted in use around drink cup 100 also has individual-multi-purpose wipe packets 106 removably attached to its exterior surface. Any or all of these wipe packets 106 may be removed by a user before the beverage or other product in cup 100 is consumed. The user may tear open one or more of the wipe packets 106 and use them to clean hands, mouth, and/or a table before consuming contents of cup 100. Such removal does not disrupt the integrity of packet 102b, which continues to function as an insulating sleeve for cup 100. After consuming the contents of cup 100, the user may elect to tear open the packet 102b which constitutes the cup sleeve 101b, and remove and use one or more towelettes contained therein.

See also FIG. 7a, depicting a wipe packet 106 which is imprinted with a design. Such a multi-purpose wipe packet alternatively may display messages, advertisements, artwork, marks, symbols, or other text. Desirably, generally rectangular packets 102a and 102b are similarly imprinted (though not illustrated here).

See also FIG. 7b, which shows a wipe packet 106 wherein a multi-purpose wipe 105 contained within is diagrammatically represented by dashed lines. Similarly, FIG. 10 shows a generally rectangular packet 102b wherein multi-purpose wipes 105 contained within are correspondingly represented.

As described generally above, FIG. 4 shows an embodiment of the invention wherein a cup sleeve 121b is formed from two attached packets. A cylindrical sleeve is formed by multi-purpose wipe packet 102b which, in use, wraps around drink cup 100 and is sealed to itself at seam (or juncture) 110. The cup sleeve 121b further comprises an additional multi-purpose wipe packet 112 extending from juncture 113a. As shown, juncture 113a is adjacent the aforementioned juncture 110. In an alternative embodiment, juncture 113 is somewhat spaced apart circumferentially from juncture 110. The additional multi-purpose wipe packet 112 is about half the circumference of the cylindrical sleeve formed by generally rectangular packet 102b and is removably attached thereto at juncture 113 and one or more appropriate places such as the position at 113b. In use, the additional wipe packet 112 may be removed from the cup sleeve 121b and opened before the user consumes the contents of the cup, without destroying the integrity of the wipe packet 102b. Thus the insulating quality of the cup sleeve 121b remains while the contents are being consumed, and a multi-purpose wipe inside the wipe packet 102b may thereafter be extracted from the packet 102b and used as a fresh towelette.

FIG. 6 shows a cup sleeve 131b in use around a beverage cup 100. The cup sleeve 131b has a cylindrical sleeve formed from one multi-purpose wipe packet 102b the ends of which are connected to each other at seam or juncture 110. Detachably attached to the generally rectangular packet 102b at a junctures 113a and 113b is a strip of three multi-purpose wipe packets 111. To show how one or more towelettes may be removed and applied before a user consumes the contents of cup 100, FIG. 6 depicts a state wherein a user has detached the strip of wipe packets 111 from juncture 113b, but has not yet removed any of the packets 111 nor detached the strip from juncture 113a. The next step of use would be for the user to detach the strip of packets 111 at juncture 113a, whereby the user would be able to open one or more of the packets in the strip 111 and use the contents of such packet(s) for cleaning purposes. Remaining about the cup 100 would be the cylindrical sleeve formed from packet 102b, providing ongoing insulation to the user's fingers. After consuming the contents of the cup 100, the user would be free to open the packet 102b and remove and then use the contents, one or more multi-purpose wipes.

FIG. 11a, FIG. 11b, FIG. 11c, FIG. 11d, and FIG. 11e illustrate the embodiment of an insulating telescopic cup sleeve adapted for use with a cup for hot or cold food or beverages. FIG. 11a shows an embodiment of the invention wherein a cup sleeve 201b, nested within cup sleeve 201a, each formed from a single multi-purpose wipe packet containing one or more multi-purpose wipes. The ends of generally rectangular packet 202a are joined together to form seam 210a. FIG. 11b shows the formerly nested cup sleeves 201b and 201a now expanded onto the body of the cup 200. Each cup sleeve is formed from a single generally rectangular packet 202b and 202a, respectively, whose ends are joined together to form seams 210b and 210a, respectively. The expanded telescopic cup sleeve allows a user's hand to be insulated over a wider surface of the cup. FIG. 11c shows an alternative embodiment of the invention wherein the lower cup sleeve has been removed from cup 200. Cup sleeve 201a, formed by joining the ends of generally rectangular packet 202a to form seam 210a, remains on cup 200. Such removal of the lower cup sleeve does not disrupt the integrity of cup sleeve 201a, which continues to function as an insulating sleeve for cup 200. The user may elect to tear open the removed cup sleeve and use one or more of the multi-purpose wipes contained therein for a variety of purposes, such as to clean the fingers, hand, mouth, or face of an adult, child, or baby; clean surfaces where a beverage and/or food item is consumed; clean automobile surfaces, such as the instrument panel, dash board, steering wheel, door handles, seat, and the like; clean spills on clothing including pants, shirts, blouses, sport coats, skirts, and dresses; and clean a pet or the pet's mouth. Or, the user may retain the removed cup sleeve for future use. FIG. 11d exemplifies the use of multi-purpose wipe 260 taken from a cup sleeve removed from a packet, such as the packet 202b of cup sleeve 201b of FIG. 11b, to clean the mouth and face of the user 240. Alternatively, as exemplified in FIG. 11e, the multi-purpose wipe 260 may be used to clean the surface of an automobile steering wheel 250.

FIG. 12a, FIG. 12b, and FIG. 12c illustrate an alternative embodiment of an insulating telescopic cup sleeve adapted for use with a cup for hot or cold food or beverages. FIG. 12a shows an embodiment of the invention wherein a cup sleeve 301b, nested within cup sleeve 301a, each formed from a generally rectangular packet 302a containing one or more multi-purpose wipes. The cup sleeves are further banded together by ring band 320a sealed closed by sealing means 321a. Ring band 320a may be attached permanently or removably to cup 300, for example with double-sided tape. The ends of generally rectangular packet 302a are joined together to form seam 310a. FIG. 12b shows the insulating telescopic cup sleeve wherein ring band 320b is opened to allow the nested cup sleeves, 301a and 301b to be expanded. FIG. 12c shows the formerly nested cup sleeves 301a and 301b now expanded up opened ring band 320c onto the body of the cup 300. Each cup sleeve is formed from single generally rectangular packets 302a and 302b, respectively, whose ends are joined together to form seams 310a and 310b, respectively. The expanded telescopic cup sleeve allows a user's hand to be insulated over a wider surface of the cup. The lower cup sleeve 301b may be removed from the cup 300 and a user may elect to tear open the removed cup sleeve and use one or more of the towelettes contained therein. Or, the user may retain the removed cup sleeve for future use. The upper cup sleeve 301a remains on cup 300 for continued insulation of the cup from the user.

FIG. 13a, FIG. 13b, and FIG. 13c is a perspective view of various stages of an alternative embodiment of the invention showing a wrapped insulating cup 400 having an cup sleeve 401 formed by wrapping a generally rectangular packet 402, containing one or more multi-purpose wipes, around the cup. FIG. 13a shows a cup 400 and a generally rectangular packet 402 having a rectangular overall shape, the longer sides are longer than the circumference of the cylindrical shape of the cup near the top. Affixed to the inner surface of the multi-purpose wipe packet 402 is an adhesive strip 430 which allows the packet to be removably attached to the cup 400. FIG. 13b illustrates the partial attachment of the generally rectangular packet 402 to cup 400. As generally rectangular packet 402 is wrapped around cup 400, adhesive strip 430 allows the generally rectangular packet to adhere to the cup and to exposed sections of itself. FIG. 13c shows wrapped insulating cup sleeve 401 formed from wrapping generally rectangular packet 402 containing one or more multi-purpose wipes around cup 400 and generating an overlap 440 of the generally rectangular packet over itself.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the various aspects stated herein.

1. An insulating cup sleeve adapted for use with a cup for hot or cold food or beverages, the cup sleeve consisting essentially of a generally rectangular packet containing one or more multi-purpose wipes, wherein the shorter ends of the generally rectangular packet are secured to each other at a juncture to form a generally cylindrical sleeve, the inner circumference of the sleeve being approximately the exterior circumference near the top of the cup with which it is adapted to be used, and wherein the vertical dimension (height) of the sleeve is about 2 to 3 inches.

2. The insulating cup sleeve of claim 1, wherein the shorter ends of the generally rectangular packet are secured together with a permanent adhesive.

3. The insulating cup sleeve of claim 1, wherein the exterior surface of the insulating cup sleeve is textured, whereby the cup sleeve can be readily gripped without slipping from the user's fingers.

4. The insulating cup sleeve of claim 3, wherein the textured exterior surface has indentations, dimples, pimples, protrusions, raised or engraved lines or grids, or Braille-like dots.

5. The insulating cup sleeve of claim 1, wherein the generally rectangular packet further comprises an opening means selected from the group of perforations, scoring, zipper-like device, and a fitment opened with the aid of an attached string, filament, or pull-tab, to facilitate access to the multi-purpose wipes therein.

6. The insulating cup sleeve of claim 1, wherein the exterior surface of the insulating cup sleeve is imprinted with a message, advertisement, or other text, artwork, designs, marks, symbols, or the like.

7. The insulating cup sleeve of claim 1, further comprising an additional generally rectangular packet containing one or more multi-purpose wipes, wherein one of the shorter ends of the additional generally rectangular packet is secured to the aforesaid juncture, whereby the additional generally rectangular packet wraps fully or partially around the generally cylindrical sleeve, and the other of the shorter ends of the additional generally rectangular packet is removably affixed to the exterior surface of the sleeve, whereby a user who opens the additional (exterior) generally rectangular packet may remove a wet wipe and use it to clean oneself before consuming the contents of the cup, while keeping the contents of the first mentioned (interior) generally rectangular packet fresh for subsequent use.

8. The insulating cup sleeve of claim 7, wherein the additional generally rectangular packet wraps fully around the generally cylindrical cup sleeve, and the other of the shorter ends is removably secured at or near the aforesaid juncture.

9. The insulating cup sleeve of claim 7, wherein the additional generally rectangular packet wraps around about half of the cylindrical sleeve.

10. The insulating cup sleeve of claim 7, wherein the additional generally rectangular packet is removably secured to the cup sleeve using a temporary securement means such as double-sided tape, glue, Velcro, or other temporary means.

11. The insulating cup sleeve of claim 10, wherein at least one of the generally rectangular packets has a textured surface that aids in gripping the cup sleeve.

12. The insulating cup sleeve of claim 11, wherein the textured surface has indentations, dimples, pimples, protrusions, raised lines or grids, or Braille-like dots.

13. The insulating cup sleeve of claim 7, wherein the generally rectangular packets are imprinted with text, messages, advertisements, artwork, designs, marks, or other symbols.

14. An insulating cup sleeve adapted for use with a cup for hot or cold food or beverages, the cup sleeve consisting essentially of two or more serially connected generally rectangular packets each containing one or more multi-purpose wipes, wherein the shorter ends of each generally rectangular packet are secured together at a juncture to form a generally cylindrical sleeve, the inner circumference of the sleeve being approximately the exterior circumference near the top of the cup with which it is adapted to be used, and wherein the vertical dimension (height) of the sleeve is about 2 to 3 inches, whereby a user who opens one of the generally rectangular packet may remove a wet wipe and use it to clean oneself before consuming the contents of the cup, while keeping the contents of any other generally rectangular packet fresh for subsequent use.

15. The insulating cup sleeve of claim 14, wherein the horizontal dimension (length) of each generally rectangular packet is approximately half of the circumference of the generally cylindrical sleeve, whereby two generally rectangular packets together constitute a cylindrical sleeve.

16. The insulating cup sleeve of claim 14, wherein the shorter ends of the generally rectangular packets are secured together with permanent adhesive.

17. The insulating cup sleeve of claim 14, wherein the insulating cup sleeve has a textured surface that aids in gripping the cup and cup sleeve.

18. The insulating cup sleeve of claim 17, wherein the textured surface has indentations, dimples, pimples, protrusions, raised or engraved lines or grids, or Braille-like dots.

19. The insulating cup sleeve of claim 14, wherein a surface of the insulating cup sleeve is imprinted with a message, advertisement, or other text, artwork, designs, marks, symbols, or the like.

20. The insulating cup sleeve of claim 14, wherein the generally rectangular packets further comprise an opening means selected from the group of perforations, scoring, zipper-like device, and a fitment opened with the aid of an attached string, filament, or pull-tab, to facilitate access to the multi-purpose wipes therein.

21. An insulating telescopic cup sleeve adapted for use with a cup for hot or cold food or beverages, the telescopic cup sleeve comprising two nested cup sleeves each consisting essentially of a generally rectangular packet, wherein the shorter ends of each generally rectangular packet are secured to each other at a juncture to form a generally cylindrical sleeve, the inner circumference of the outer cup sleeve being approximately the exterior circumference near the top of the cup with which it is adapted to be used, the outer circumference of the inner cup sleeve being slightly less than the inner circumference of the outer cup sleeve, wherein the vertical dimension (height) of the each cup sleeve is about 1 to 3 inches, and wherein the nested cup sleeves are affixed to a cup for hot or cold food or beverages, wherein the outer cup sleeve may be telescoped up from the inner cup sleeve onto the cup until the outer cup sleeve embraces the cup, thereby forming the telescoped cup sleeve, and wherein the generally rectangular packet may consist of one multi-purpose wipe packet or multiple serially-connected multi-purpose wipe packets, each containing one or more multi-purpose wipes.

22. The insulating telescopic cup sleeve of claim 21, wherein the shorter ends of each generally rectangular packet is secured together with a permanent adhesive.

23. The insulating telescopic cup sleeve of claim 21, wherein the exterior surface of each nested cup sleeve is textured, whereby each of the nested cup sleeves can be readily gripped without slipping from the user's fingers.

24. The insulating telescopic cup sleeve of claim 23, wherein the textured exterior surface of each nested cup sleeve has indentations, dimples, pimples, protrusions, raised or engraved lines or grids, or Braille-like dots.

25. The insulating telescopic cup sleeve of claim 21, wherein the exterior surface of each generally rectangular packet is imprinted with a message, advertisement, or other text, artwork, design, mark, symbol, or the like.

26. The insulating cup sleeve of claim 21, wherein each generally rectangular packet further comprises an opening means selected from the group of perforations, scoring, zipper-like device, and a fitment opened with the aid of an attached string, filament, or pull-tab, to facilitate access to the multi-purpose wipes therein.

27. The insulating telescopic cup sleeve of claim 21, further comprising a band ring comprised of paper, plastic, or a synthetic material, and having a quick-release attachment means for holding the nested cup sleeves together on the cup until the quick-release attachment means is opened to allow the outer cup sleeve to be telescoped up from the inner cup sleeve onto the cup until the outer cup sleeve embraces the cup, thereby forming the telescoped cup sleeve, wherein the band ring is affixed to the cup.

28. The insulating telescopic cup sleeve of claim 27, wherein the exterior surface of each nested cup sleeve is textured, whereby each of the nested cup sleeves can be readily gripped without slipping from the user's fingers.

29. The insulating telescopic cup sleeve of claim 28, wherein the textured exterior surface of each nested cup sleeve has indentations, dimples, pimples, protrusions, raised or engraved lines or grids, or Braille-like dots.

30. The insulating telescopic cup sleeve of claim 27, wherein the exterior surface of each generally rectangular packet is imprinted with a message, advertisement, or other text, artwork, design, mark, symbol, or the like.

31. The insulating telescopic cup sleeve of claim 27, wherein the quick-release attachment means consists of a non-permanent adhesive or is formed of double-sided adhesive tape.

32. A wrapped insulating cup sleeve adapted for use with a cup for hot or cold food or beverages, the cup sleeve formed from one generally rectangular packet, wherein the length of the packet is greater than the exterior circumference near the top of the cup with which it is adapted to be used, wherein the vertical dimension, or height, of the sleeve is about 2 to 3 inches, wherein the packet has a strip of adhesive or tape having a protective means affixed to the inner surface, wherein removal of the protective means allows the user to wrap the generally rectangular packet around a cup and the adhesive binds the generally rectangular packet both to the cup and to itself forming the wrapped insulating cup sleeve, and wherein said generally rectangular packet consists of a single packet, or two or more serially-attached packets, each containing one or more multi-purpose wipes.

33. The insulating cup sleeve of claim 32, wherein the length of the generally rectangular packet is at least twice the circumference near the top of the cup with which it is adapted to be used, and wherein a double-layer insulating cup sleeve is formed.

34. The insulating cup sleeve of claim 32, wherein the adhesive is a non-permanent adhesive.
